(19) United States
(12) Patent Application Publication
(10) Pub. No.: US 2004/0192186 A1
(43) Pub. Date: Sep. 30, 2004

(54) Portable air filtration apparatus

(75) Inventors: Therese Bourgeois, Minnetrista, MN (US); Jerry Mithuen, Eden Prairie, MN (US); A. Ray Boyd, Robbinsdale, MN (US)

Correspondence Address: SUGHRUE MION, PLLC, 2100 Pennsylvania Avenue, NW, Washington, DC, 20037-3213, US

(73) Assignee: PRECISION AIR PRODUCTS CO.

(21) Appl. No.: 10/393,985

(22) Filed: Mar. 24, 2003

(51) Int. Cl. B01L 1/04

(52) U.S. Cl. 454/187; 55/385.2

(57) ABSTRACT

Provided is a filtering system and method that incorporates a portable filter device. The portable filter has a front side and a back side. A medical gurney is positioned proximate the portable filter device. An air intake provided in the back side of the portable filter device and an air outlet diffusion plate provided in the front side of the portable filter device. A first filter is disposed across the air intake and a second filter is disposed behind the air outlet diffusion plate. Also provided is an air drawing device which draws air into the portable filter device through the first filter and sends air out of the filter device through the second filter. Filtered streams of air are then formed above and below a patient supporting area of the gurney, such that the filtered streams of air have a laminar flow. Rollers are provided for permitting the portable filter device to be moved across a floor surface.

### BACKGROUND OF THE INVENTION

1. Field of the Invention

Methods and apparatuses consistent with the present invention relate to a portable air filtration system. Illustrative embodiments of the invention relate to methods and apparatuses for providing filtered air over a patient during a medical procedure, surgical procedure, or the like.

2. Description of the Related Art

Airborne bacteria and other airborne contaminants are known to be a primary cause of post operative infection in operating rooms. The risk of infection is increased when the operations are long in duration and in situations where a portion of the body to be operated on covers a large surface area. Present day preoperative procedures involve sterilization of equipment, operating room and surgical garments. However, even with the wearing of sterilized outer garments and masks, a bacteria count within an operating room can often reach amounts which result in infection.

Various systems have been used in operating rooms to filter air in an effort to remove airborne particles. However, the filtering of air supplied to the operating room is often insufficient to adequately reduce harmful airborne contaminants, due to filter location and air movement. Other known permanent systems rely on delivering large quantities of air to a center of the operating room such that air pressure within an operative zone is greater than a pressure outside the zone, so as to keep out contaminants. Some of these systems include filters which are mounted into a wall portion of an operating room. Such systems use air curtain plenums to aid in directing the air flow, so as to circulate air over an operating area. However, these systems are permanently affixed to a wall of the room, or are just too large to be readily moved.

In various conventional systems, filtered air is introduced through ducts and registers in a ceiling such that a vertical flow of air is forced downwardly upon an operating table and the operating area surrounding it, in an effort to create a clean air zone from which contaminants are flushed. However, ceiling mounted systems occupy large portions of the ceiling area and are generally mounted in a suspended ceiling having removable ceiling panels such that the system can be accessed for maintenance and repair. Accordingly, ceiling space is lost which could otherwise be used for supporting medical equipment, and the suspended ceilings tend to collect contaminants which are difficult to clean. Moreover, the vertical flow of air is often disrupted by surgical lights and other equipment provided in the clean air zone.

Attempts have also been made at providing a portable apparatus for filtering air in an operating room environment. For example, it has been attempted to create a portable filtration system, wherein air is directed downwardly on top of a patient from a horizontally positioned output face that is located above a patient's bed. However, such systems are not suitable for surgical environments where equipment and doctors need to extend into the area above an operating table, not to mention that vertically descending air may actually insert unwanted contaminates into a surgical area.

### SUMMARY OF THE INVENTION

Illustrative, non-limiting embodiments of the present invention overcome the disadvantages described above and other disadvantages. Also, the present invention is not required to overcome the disadvantages described above and the other disadvantages, and an illustrative, non-limiting embodiment of the present invention may not overcome any of the disadvantages.

An illustrative, non-limiting embodiment of the present invention provides a filtering system including a portable filter device having a front side and a back side. A medical gurney having a patient supporting area is positioned proximate the portable filter device. An air intake is provided in the back side of the portable filter device and an air outlet diffusion plate is provided in the front side of the portable filter device. A pre-filter is disposed across the air intake and a second HEPA (high efficiency particulate air) filter is disposed behind the air outlet diffusion plate. Also provided is a fan or blower for drawing air into the portable filter device through the first filter and pushing air out of the filter device through the second HEPA filter. This forms filtered streams of air that are then provided above and below the patient supporting area of a gurney or surgical table, where the filtered streams of air have a laminar flow. Also provided are roller means for permitting the portable filter device to be moved across a floor surface.

In further accordance with a non-limiting embodiment of the present invention, the laminar flow is provided horizontally across the patient supporting area of the gurney or surgical table so that eddies of air are not present throughout a predetermined area over the gurney thus effectively isolating the predetermined area over the patient supporting area from unfiltered air. Moreover, the laminar flow is also provided across a bottom of the patient supporting area of the gurney or surgical table so that eddies of air are not present throughout a predetermined distance under the patient supporting area thus effectively isolating the predetermined distance under the patient supporting area from unfiltered air.

Another illustrative, non-limiting embodiment of the present invention provides a method of directing a filtered stream of air across a patient on a gurney during a medical procedure. The method includes providing a portable filtering device and moving the portable filtering device from a first position to a second position. The second position being proximate to a side of the gurney. The gurney includes a patient supporting area. The portable filtering device is powered on to provide a laminar flow of filtered air in a direction along the top and bottom of the patient supporting area of the gurney or surgical table.

In even further accordance with a non-limiting embodiment of the invention, the laminar flow of air is drawn into the portable filtering device through a first filter and out of the portable filtering device through a second filter so that the filtered air is provided horizontally across the patient supporting area of the gurney. Also, the laminar flow of air is provided horizontally below the patient supporting area of the gurney. The laminar flow of air may also be horizontal in relation to a floor beneath the gurney.

Features of the present invention include the ability to provide a mobile filter device system in a hospital or other less sterile environments where space is limited and emergency situations may arise sporadically in different locations. The system and device are capable of providing filtered air over a surgical area and can be moved from one area to another in a short amount of time. Because filtered air is blown across a site of surgery, it provides a contamination free controlled environment that assists in the reduction of post-operative infection. Such features aid in providing a predominantly zero bacteria count at a surgical wound when the proper sepsis control procedures are followed. Accordingly, the rapid air change provided by the invention substantially removes bacteria shed by people or other sources in a quick and efficient manner.

### BRIEF DESCRIPTION OF DRAWINGS

Aspects of illustrative, non-limiting embodiments of the present invention will become more apparent by describing in detail non-limiting embodiments thereof with reference to the attached drawings, in which:

FIG. 1 is an overall perspective view of a non-limiting embodiment of the invention installed within an operating room shown with phantom lines;

FIG. 2 is a perspective front view of an illustrative and non-limiting embodiment of the invention;

FIG. 3 is a perspective rear view of an illustrative and non-limiting embodiment of the invention;

FIG. 4 is a sectional view of a non-limiting embodiment of an air filter device taken along the lines 4-4 of FIG. 2;

FIG. 5 is a side view of filtering system according to an illustrative, non-limiting embodiment of the present invention; and

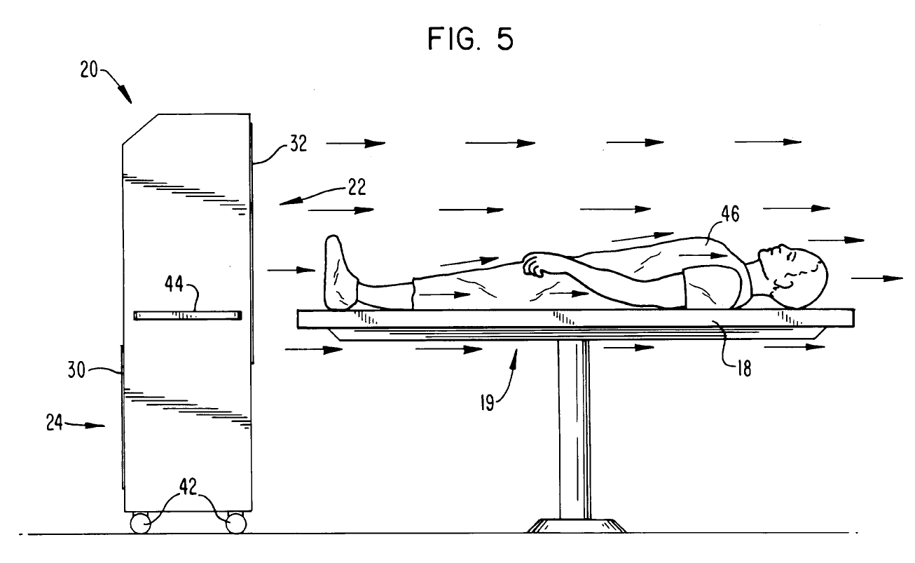

FIG. 6 is a flow chart repressing aspects of a method according to a non-limiting embodiment of the present invention.

### DETAILED DESCRIPTION OF ILLUSTRATIVE, NON-LIMITING EMBODIMENTS

The following description of illustrative, non-limiting embodiments of the invention discloses specific configurations, components, processes and operations. However, the embodiments are merely examples of the present invention and, thus, the specific features described below are merely used to more easily describe such embodiments and to provide an overall understanding of the present invention. Accordingly, one skilled in the art will readily recognize that the present invention is not limited to the specific embodiments described below. Furthermore, the descriptions of various configurations, components, processes and operations of the embodiments that are known to one skilled in the art are omitted for the sake of clarity and brevity.

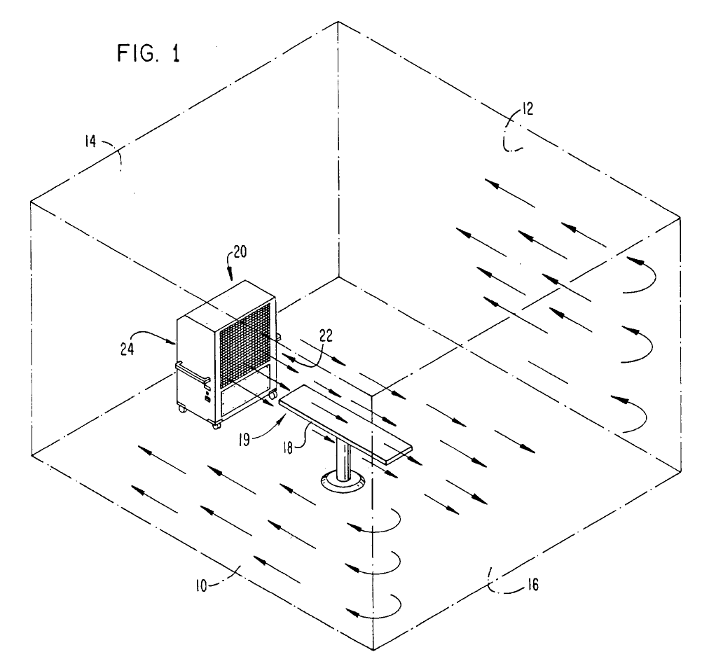

FIG. 1 shows a conventional hospital operating room having side walls 10 and 12, a ceiling 14 and a floor 16. Operating rooms traditionally include various medical apparatuses, a surgical team and overhanging lights (not shown). A table (hereinafter “gurney”) 18 is used for supporting a patient. The table 18 may be a surgical table or any other table or the like that is used to hold the patient off the ground. The gurney 18 has a patient supporting area 19 on which the patient lays. Although FIG. 1 is described as being a hospital room, it will be appreciated that such a room or area can be in any environment where medical attention is required.

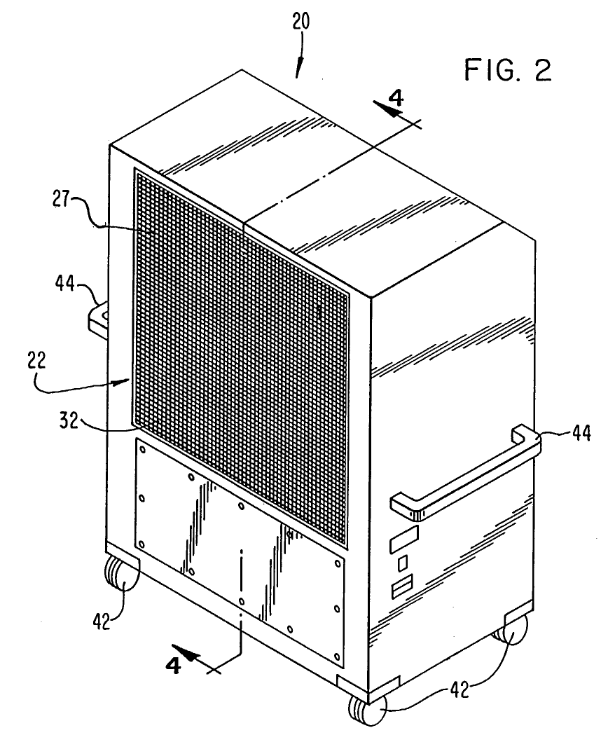

With addition reference to FIGS. 2-4, a non-limiting embodiment of the present invention includes an air filter device 20, which is to be situated proximate an end of the gurney 18. The air filter device 20 includes a front filter assembly 22 and an air intake 24. The front filter assembly 22 includes a filter medium 26 behind an air outlet diffusion plate 27. The air outlet diffusion plate 27 in one embodiment is positioned in an upper front portion of the filter device 20. The filter medium 26 may be, for example a high efficiency particulate air (HEPA) filter which removes 99.99% of all particles 0.3 microns or larger. A filter medium 28 is provided across an air intake 24. The air intake 24 in one embodiment is positioned in a lower back portion of the filter device 20. As one skilled in the art will appreciate, various types and combinations of filters may be used, such as 30% efficient pleated pre-filters. Also, louvers 30 may be provided over the air intake 24 to effect the flow of air into the filter device 20. Although the louvers 30 are shown to be horizontally positioned, it will be appreciated that they may be positioned vertically.

The front filter assembly 22 forms an air discharge face that is covered with the air outlet diffusion plate 27. The air outlet diffusion plate 27 is formed with multiple apertures, so as to aid in the flow of air out of the air filter device 20. In one illustrative embodiment, the air outlet diffusion plate 27 is comprised of 0040 aluminum perforated to accommodate a free area in a range of 23% to 33%, for example. Also, the air outlet diffusion plate 27 may be formed with 3/32″ holes having staggered or straight 3/16″ centers. Hole size, patterns and spacing may vary as long as it produces laminar airflow.

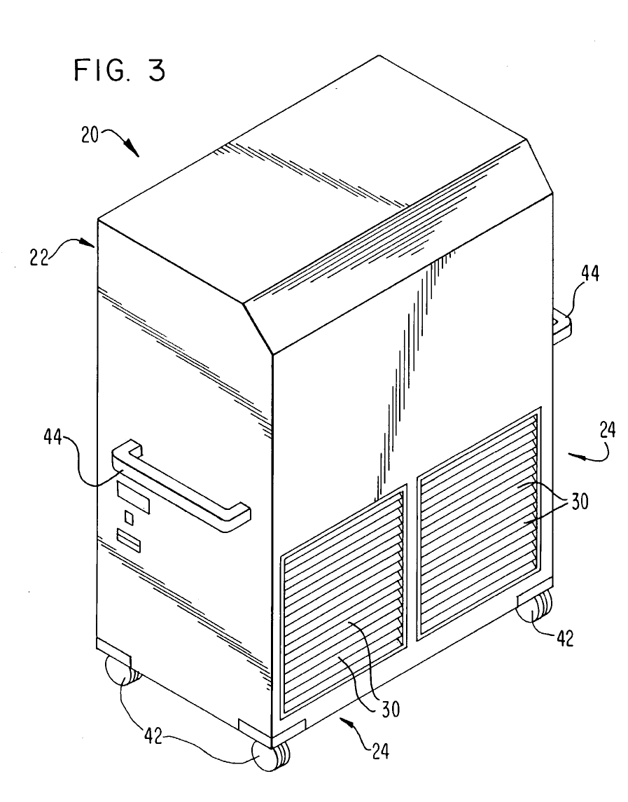

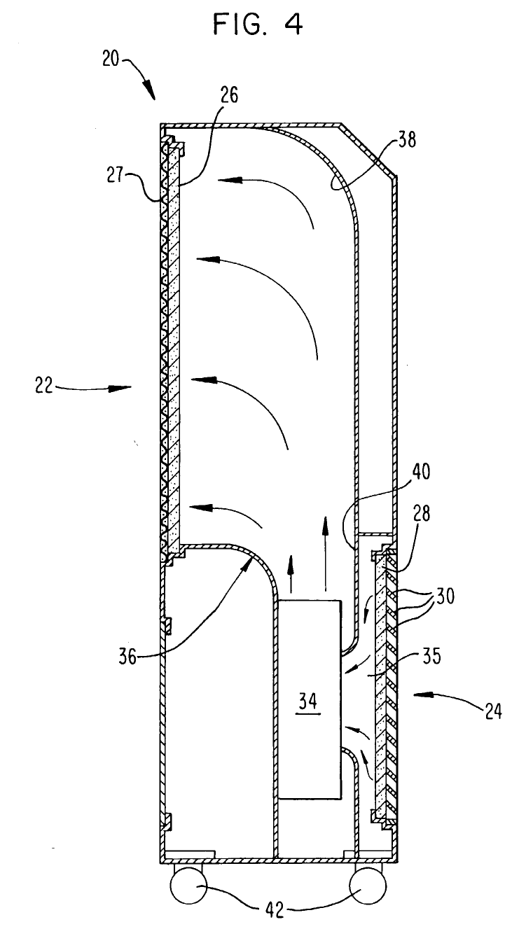

As shown in FIG. 4, a blower 34 having a motorized impeller is provided within the air filter device 20. As one skilled in the art will appreciate, the blower 34 may be, for example, a scroll type centrifugal blower or the like, including a single or double inlet with airfoil, backward or forward curved blade type, with or without a scroll, direct drive or belt duty. The blower 34 acts to draw air into and through the air intake 24, guide the air to the blower 34 through an opening 35 formed in a partition 40, and then direct the air out of the front filter assembly 22. The blower 34 is positioned proximate the air intake 24 and produces the desired air flow within the assembly through the use of deflecting panels. The deflecting panels include a lower deflecting panel 36 and an upper deflecting panel 38. It is noted that two separate air intakes 24 may be provided, as shown in FIG. 3. The described configuration allows for air to be efficiently pulled through the air intake 24 and discharged through the front filter assembly 22.

In an illustrative non-limiting embodiment, the filter device is approximately 60″ tall, 54″ wide, and has a thickness of 18″. It is conceivable that the height may be in a range of 54″ to 66″; the width in a range of 48″ to 60″; and the thickness in a range of 12″ to 24″. The air outlet diffusion plate 27 in one embodiment has a height of 36″ and a width of 48″. It is also conceivable that the height of the diffusion plate 27 may be in a range of 30″ to 42″ and the width in a range of 42″ to 54″. These dimensions permit the device to be easily maneuvered between different settings, and also may contribute to the desired flow of air over and under the patient supporting area 19 of the gurney 18. A standard gurney 18 may have dimensions of 24 ″×76″, or other traditionally used dimensions. Thus, the air outlet diffusion plate 27 may be wider than a side of the gurney 18 . The patient supporting area 19 may be flat and have one side that faces a patient, and another side that faces the floor 16. The patient supporting area 19 is typically placed at a height of around 3′ above the floor 16. Thus, when the filter device 20, according to one embodiment of the invention, is positioned proximate an end of the gurney 18, a laminar air flow is directed above and below the patient supporting area 19 of the gurney 18 in such a manner that a patient receives clean, filtered air, without contaminates outside the flow of the air being pulled into the area surrounding the patient. Laminar air flow is present over the face of the air outlet diffusion plate 27 and extends, for example, substantially 48″ from the air outlet diffusion plate 27 to form a bullet shape and may taper down to nothing after about 48″, or in the range of 42″ to 54″, both horizontally and vertically.

In one embodiment, an end portion of the patient supporting area 19 is positioned so as to be substantially in the range of 1″ to 18″ from the air filter device 20. However, this distance may change depending on the application. It may be desired to place the air outlet diffusion plate 27 as close to the surgical site as possible to realize maximum benefit of the HEPA filtered, laminar air flow.

In further accordance with the present invention, the filter device includes a set of protrusions that contact the floor 16 and allow for the air filter device 20 to be easily moved from one point to another. These protrusions may consist of, for example, wheels, casters or rollers 42 or other configurations that reduces friction between the filter device 20 and the floor 16. The decided on protrusions are fastened or bolted to the filter device 20 so as to allow for the device 20 to be moved whenever it is needed, without the need for special moving equipment. Any combination of wheels or rollers 42 may be used to allow for the device to be easily maneuvered from one setting to another. For example, one or two wheels or rollers may be sufficient, if a side of the filter device 20 is manually lifted off the floor 16.

The ability to provide a mobile filter device is beneficial in hospital environments where space is limited and emergency situations may appear sporadically in different locations. However, the filter device 20 is not limited to being used in a hospital setting and can be provided in any location where filtered air is needed for a medical or surgical procedure. For example, and not by limitation, the filter device 20 may be provided in a tent setting of an emergency area, or an “on the scene” environment where medical attention is required. The size and mobility of the filter device 20 also permit it to be carried in vehicle to an area of need.

The filter device 20 is also provided with handles 44, which further aid in the mobility of the filter device 20. Accordingly, the filter device 20, according to an illustrative embodiment of the invention, is capable of providing filtered air over a surgical area and can be moved from one area to another in a short amount of time. Such features increase efficiency and reduce the amount of equipment that is needed in a hospital environment.

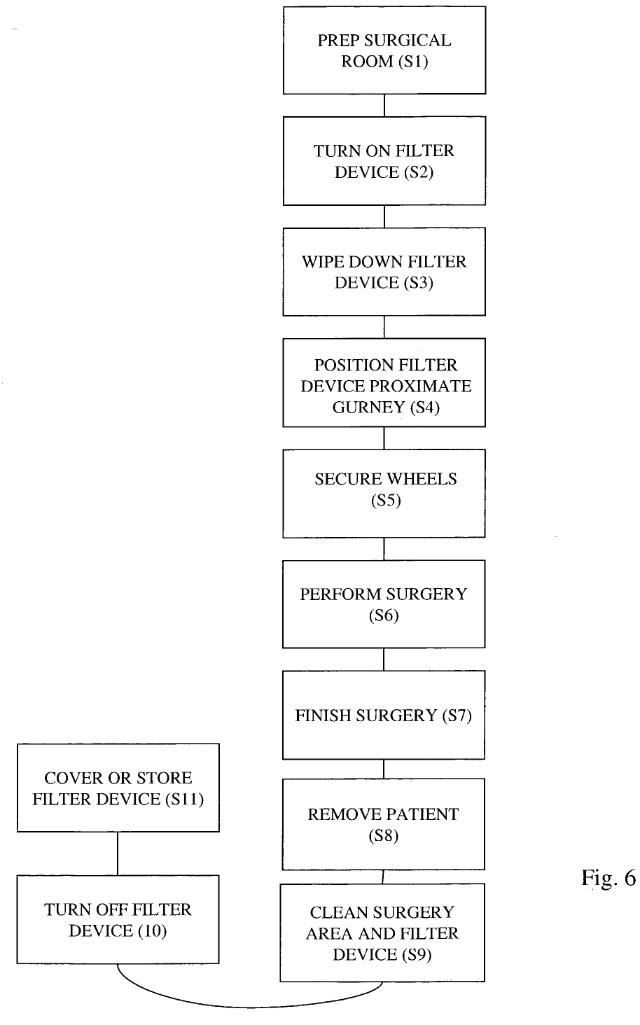

A method of using the filter device will now be described with additional reference to FIG. 6. Prior to performing a surgical procedure, the surgical room is prepped according to the standard operating procedure know in the art (S1). The air filter device 20 is turned on (S2) and should be wiped down to increase its sterilization (S3). Because of the air filter device's 20 unique design, it is to be positioned (S4) at a close proximity to an end or side of the gurney 18, thus allowing for the combination of the filter device 20 and gurney 18 to make an efficient use of space.

When positioned, the filter device may be, for example, a minimum of 30″ inches from the wall 14. This aids in providing a proper flow of air to the air intake 24. Also, the air intake 24 and rear filter 28, should be free of any obstructions. After the unit is positioned in the proper location, the wheels are locked (S5). The wheels 42 may be locked with a stopper (not shown), or any other sort of lock device known in the art. The locking of the wheels 42 compliments the portable aspects of the invention, by providing a device that is easily moved from point to point, while being secured in place when the filter device is positioned in a desired location.

It is often beneficial to start the unit and allow for it run for 30 minutes or so before bringing the patient in the room. After surgery begins (S6), it may be decided to have the unit run from the beginning to the end of the procedure. When the procedure is finished (S7), the patient and the surgical area should be covered, or the patient removed (S8). The surgery area and/or the filter device is then cleaned (S9) and the unit is turned off (S 10). The filter device 20 is then to be moved to a storage area or covered (S11) until its next use. These steps are then repeated for each surgical case. It will be appreciated that the aforementioned method features may be modified according to particular procedures. Also, it may not be necessary to include all steps to obtain aspects of the invention.

The velocity and form of air flow exiting from the front filter assembly play a role in providing a desired air flow, in accordance with the invention. While using an exemplary dimensional configuration and blower 34, the air filter device was found to provide the following face velocities in feet per minute (FPM) at a distance of around 1″ from the device.

Face Velocity FPM

| | | |
|---|---|---|
| 117 | 113 | 118 |
| 120 | 124 | 127 |
| 130 | 104 | 135 |

The face velocity is representative of the velocity of the air that has left the front filter assembly 22, but is still in close proximity to the filter device. Thus, as one skilled in the art will appreciate, the above chart represents a velocity profile. Other tests and configurations have also produced an average face velocity of 100 FPM. Further tests and configurations have produced a face velocity that is relatively uniform in nature and does not vary more than 10%.

Also, in accordance with an illustrative embodiment of the present invention, a velocity of the exiting air was measured at a position of 4″ inches above the supporting area 19 of the gurney 18, and at various locations in relation to the filter device 20. These sample, exemplary velocities are given in the following table.

| | 4″ ABOVE THE SUPPORTING AREA OF THE | | | | | |
|---|---|---|---|---|---|---|
| | GURNEY | | | | | |
| 10″ TO LEFT SIDE OF | 122 | 104 | 99 | 97 | 92 | 90 |
| CENTER OF SUPPORTING | | | | | | |
| AREA OF GURNEY | | | | | | |
| CENTER OF GURNEY | 142 | 125 | 114 | 110 | 109 | 105 |
| 10″ TO RIGHT SIDE OF | 115 | 97 | 92 | 87 | 80 | 78 |
| CENTER OF SUPPORTING | | | | | | |
| AREA OF GURNEY | | | | | | |
| | 4″ | 16″ | 26″ | 38″ | 50″ | 62″ |
| | AWAY | AWAY | AWAY | AWAY | AWAY | AWAY |

Particle counts were also measured at various positions above the patient supporting area 19 of the gurney 18, and distances away from the air filter device 20. These counts are listed in the following table.

PARTICLE COUNTS

| | Distance from Face | | | | | |
|---|---|---|---|---|---|---|
| | 14″ | 26″ | 38″ | 50″ | 62″ | 74″ |
| | 24″ Above the Supporting Area | | | | | |
| 10″ TO LEFT SIDE | 0 | 36 | 9522 | 2666 | 15787 | ???? |
| OF CENTER OF | | | | | | |
| SUPPORTING | | | | | | |
| AREA OF | | | | | | |
| GURNEY | | | | | | |
| CENTER OF | 58 | 232 | 2630 | 1788 | 10577 | 41957 |
| GURNEY | | | | | | |
| 10″ TO RIGHT | 8 | 0 | 3 | 1 | 1844 | 13284 |
| SIDE OF CENTER | | | | | | |
| OF SUPPORTING | | | | | | |
| AREA OF | | | | | | |
| GURNEY | | | | | | |
| | 16″ Above the Supporting Area | | | | | |
| 10″ TO LEFT SIDE | 3 | 3 | 0 | 0 | 1440 | 111430 |
| OF CENTER OF | | | | | | |
| SUPPORTING | | | | | | |
| AREA OF | | | | | | |
| GURNEY | | | | | | |
| CENTER OF | 0 | 7 | 19 | 11 | 21 | 21 |
| GURNEY | | | | | | |
| 10″ TO RIGHT | 8 | 0 | 3 | 1 | 1844 | 13284 |
| SIDE OF CENTER | | | | | | |
| OF SUPPORTING | | | | | | |
| AREA OF | | | | | | |
| GURNEY | | | | | | |
| | 4″ Above the Supporting Area | | | | | |
| 10″ TO LEFT SIDE | 3 | 4 | 399 | 258 | 517 | 15353 |
| OF CENTER OF | | | | | | |
| SUPPORTING | | | | | | |
| AREA OF | | | | | | |
| GURNEY | | | | | | |
| CENTER OF | 2 | 0 | 27 | 20 | 19 | 31 |
| GURNEY | | | | | | |
| 10″ TO RIGHT | 6 | 12 | 13760 | 73459 | 51366 | 55613 |
| SIDE OF CENTER | | | | | | |
| OF SUPPORTING | | | | | | |
| AREA OF | | | | | | |
| GURNEY | | | | | | |

Accordingly, by practicing the method described herein, the blower 34 uses the motorized impeller to draw air into the pleated pre-filters 28 located in the back of unit. The pre-filtered air is then moved through the high efficiency particulate air (HEPA) filter, which removes airborne contaminant particles. The air is blown across the site of surgery to provide a substantially contamination free controlled environment that assists in the reduction of postoperative infection. These features aid in providing a predominantly zero or low bacteria count at a surgical wound when the proper sepsis control procedures are followed.

Although, one of the illustrative, non-limiting embodiments describe the filter device as having particular dimensions, it will be appreciated that these dimensions can vary to accommodate a different setting, while keeping with the spirit of the invention.

Although, the filter device is described as being used in a surgical procedure, it will be appreciated that the filter device may be used in other procedures that required filtered air.

Although, the filter device is described as having an air outlet diffusion plate positioned in an upper front portion of the filter device and an air intake positioned in a lower back portion of the filter device, it will appreciated that an air outlet diffusion plate and an air inlet may be located in any portion of the device, so as to achieve a purpose of the invention.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein, but is to be accorded the widest scope as defined by the features of the claims and equivalents thereof.

What is claimed is:

1. A filtering system comprising:
a portable filter device having a front side and a back side;
a medical gurney positioned proximate said portable filter device, said gurney having a patient supporting area;
an air intake provided in the back side of said portable filter device;
an air outlet diffusion plate provided in the front side of said portable filter device;
a first filter disposed across said air intake;
a second filter disposed behind said air outlet diffusion plate;
means for drawing air into said portable filter device through said first filter and delivering the air out of said filter device through said second filter so that filtered streams of air are provided above and below said patient supporting area of said gurney, the filtered streams of air having a laminar flow; and
at least one roller which permits the portable filter device to be moved across a floor surface.

2. The filtering system of claim 1, wherein the laminar flow is provided horizontally across said patient supporting area of said gurney so that eddies of air are not present throughout a predetermined area over said gurney thus effectively isolating the predetermined area over said patient supporting area from unfiltered air.

3. The filtering system of claim 1, wherein the laminar flow is also provided across a bottom of said patient supporting area of said gurney so that eddies of air are not present throughout a predetermined distance under said patient supporting area thus effectively isolating the predetermined distance under said patient supporting area from unfiltered air.

4. The filtering system of claim 1, wherein a plurality of rollers are provided, and said plurality of rollers are in the form of wheels or casters.

5. The filtering system of claim 1, wherein said at least one roller has a lock which acts to hold said portable filter device in a desired position in relation to said patient supporting area of said gurney.

6. The filtering system of claim 1, wherein said air outlet diffusion plate includes a plurality of apertures.

7. The filtering system of claim 6, wherein the apertures are positioned in the plate to form a laminar air flow.

8. The filtering system of claim 1, wherein said air outlet diffusion plate is positioned in an upper front portion of said portable filter device, and said air intake is provided in a lower back portion of said portable filter device.

9. The filtering system of claim 1, wherein said means for drawing air comprises a motor driven fan.

10. The filtering system of claim 1, wherein said means for drawing air produces an average face velocity of substantially 100 FPM.

11. The filtering system of claim 1, wherein said air outlet diffusion plate has a width which is wider than a width of said gurney.

12. The filtering system of claim 1, further including an upper deflector shield and a lower deflector shield provided in the portable filter device so as to guide air from said first filter towards said second filter.

13. The filtering system of claim 1, further including at least one handle which aids in moving the portable filter device.

14. A method of directing a filtered stream of air across a patient on a gurney during a medical procedure, comprising:
providing a portable filtering device;
moving the portable filtering device from a first position to a second position, the second position being proximate to a side of the gurney, the gurney having a patient supporting area; and
powering the portable filtering device to provide a laminar flow of filtered air in a direction along a top and bottom of said patient supporting area of said gurney.

15. The method of directing a filtered stream of air across a patient of claim 14, wherein the laminar flow of air is drawn into the portable filtering device through a first filter and sent out of the portable filtering device through a second filter so that the filtered air is provided horizontally across the patient supporting area of the gurney.

16. The method of directing a filtered stream of air across a patient of claim 15, wherein the laminar flow of air is also provided horizontally below the patient supporting area of the gurney.

17. The method of directing a filtered stream of air across a patient of claim 14, wherein the laminar flow of air is horizontal in relation to a floor beneath the gurney.

18. The method of directing a filtered stream of air across a patient of claim 14, wherein the moving of the portable filtering device is done by applying a force against a side of the portable filtering device so as to roll wheels of the portable filtering device.

19. The method of directing a filtered stream of air across a patient of claim 18, further including locking the wheels in place when the portable filtering device is located in a desired position in relation to the patient supporting area of the gurney.

20. The method of directing a filtered stream of air across a patient of claim 14, wherein the unit is operated for a period of time before a patient is placed in front of the portable filtering device.

21. The method of directing a filtered stream of air across a patient of claim 14, wherein the side of the gurney where the portable filtering device is positioned is a longitudinal end of the patient supporting area.

22. A filtering system comprising:
a portable filter device having a front side and a back side;
a medical gurney positioned proximate said portable filter device, said gurney having a patient supporting area;
an air intake provided in the back side of said portable filter device;
an air outlet diffusion plate provided in the front side of said portable filter device;
a first filter disposed across the air intake;
a second filter disposed behind the air outlet diffusion plate;
a fan which is operative to draw air into said portable filter device through said first filter and deliver the air out of said filter device through said second filter so that filtered streams of air are provided above and below said patient supporting area of said gurney, the filtered streams of air having a laminar flow; and
at least one roller which permits the portable filter device to be moved across a floor surface.

23. A portable filter device comprising:
an air intake provided in a back side of said portable filter device;
an air outlet diffusion plate provided in a front side of said portable filter device;
a first filter disposed across said air intake;
a second filter disposed behind said air outlet diffusion plate;
means for drawing air into said portable filter device through said first filter and delivering the air out of said filter device through said second filter so that filtered streams of air can be provided above and below a patient supporting area of a gurney, the filtered streams of air having a laminar flow; and
at least one roller which permits the portable filter device to be moved across a floor surface.

24. A portable filter device comprising:
an air intake provided in a back side of said portable filter device;
an air outlet diffusion plate provided in a front side of said portable filter device;
a first filter disposed across said air intake;
a second filter disposed behind said air outlet diffusion plate;
a fan which is operative to draw air into said portable filter device through said first filter and deliver the air out of said filter device through said second filter so that filtered streams of air can be provided above and below a patient supporting area of a gurney, the filtered streams of air having a laminar flow; and
at least one roller which permits the portable filter device to be moved across a floor surface.
